(19) United States
(12) Patent Application Publication
(10) Pub. No.: US 2023/0395812 A1
(43) Pub. Date: Dec. 7, 2023

(54) POROUS ASSEMBLIES AND RELATED METHODS OF FABRICATION AND USE

(71) Applicant: Mott Corporation, Farmington, CT (US)

(72) Inventors: Aravind Mohanram, Avon, CT (US); James K. Steele, Middlefield, CT (US); Matthew Siok, Farmington, CT (US)

(21) Appl. No.: 18/031,743

(22) PCT Filed: Oct. 14, 2021
(86) PCT No.: PCT/US2021/054939

§ 371 Date: Apr. 13, 2023

Related U.S. Application Data
(60) Provisional application No. 63/092,202, filed on Oct. 15, 2020.

(51) Int. Cl. H01M 4/86; H01M 4/88; B33Y 10/00; B33Y 80/00; C25B 11/031; C25B 11/063; B01D 69/10

(52) U.S. Cl. CPC H01M 4/861; H01M 4/8621; H01M 4/8875; B33Y 10/00; B33Y 80/00; C25B 11/031; C25B 11/063; B01D 69/108; B22F 10/28

(57) ABSTRACT

The present disclosure provides advantageous porous assemblies, and improved systems and methods for utilizing and/or fabricating the porous assemblies. More particularly, the present disclosure provides porous assemblies fabricated at least in part by additive manufacturing (e.g., via a 3D printing process, such as, for example, via an electron beam additive manufacturing process, via a laser additive manufacturing technology, via an inkjet or a binder jet additive manufacturing process, etc.), the porous assemblies including a porous monolith support structure or substrate for a sensitive or active layer of a multi-layer application (e.g., for sensitive/active layers in fuel cell/electrolyzer/battery and other multi-layer applications).

### CROSS-REFERENCE TO RELATED APPLICATION

The present application claims priority benefit to a U.S. Provisional Patent Application which was filed on Oct. 15, 2020, and assigned Ser. No. 63/092,202, the entire contents of which is incorporated herein by reference in its entirety.

### FIELD OF THE DISCLOSURE

The present disclosure relates to porous assemblies and related methods of fabrication and use and, more particularly, to porous assemblies fabricated at least in part by additive manufacturing (e.g., via a 3D printing process, such as, for example, via an electron-beam additive manufacturing process, via a laser additive manufacturing technology, via an inkjet or a binder-jet additive manufacturing process, etc.), the porous assemblies including a porous monolith support structure or substrate for a sensitive or active layer of a multi-layer application (e.g., for sensitive/active layers in fuel cell/electrolyzer/battery/other multi-layer applications).

### BACKGROUND OF THE DISCLOSURE

Current practice provides for an assembly of multiple separate/individual porous layers (e.g., conventional screens/sintered metal porous metal media) to build a multi-layer support structure for sensitive/active layers of multi-layer applications (e.g., for sensitive/active layers in fuel cell/electrolyzer/battery/other multi-layer applications). Such multi-layer assemblies are repeated throughout the stack structure. For example, a typical fuel cell stack may have tens of such multi-layer assemblies, if not more. This often results in multiple/costly fabrication and additional processing (such as application of coating on each separate/individual layer before fabrication) steps. Also, the performance (e.g., fluid flow resistance) that is achieved can be limited by the lack of flexibility in designing the pore structure and/or dimensions of the multiple separate porous layers (e.g., conventional screens/sintered metal porous metal media).

An interest exists for improved assemblies and related methods of fabrication and use.

These and other inefficiencies and opportunities for improvement are addressed and/or overcome by the assemblies, systems and methods of the present disclosure.

### BRIEF SUMMARY OF THE DISCLOSURE

The present disclosure provides advantageous porous assemblies, and improved systems/methods for utilizing and/or fabricating the porous assemblies. More particularly, the present disclosure provides porous assemblies fabricated at least in part by additive manufacturing (e.g., via a 3D printing process, such as, for example, via an electron-beam additive manufacturing process, via a laser additive manufacturing technology, via an inkjet or a binder-jet additive manufacturing process, etc.), the porous assemblies including a porous monolith support structure or substrate for a sensitive or active layer of a multi-layer application (e.g., for sensitive/active layers in fuel cell/electrolyzer/battery/other multi-layer applications).

It is noted that the porous monolith support structure or substrate (e.g., fabricated at least in part by additive manufacturing) of the present disclosure can be assembled with and/or joined to conventional porous media, and/or can be assembled with and/or joined to other porous monolith support structure or substrates of the present disclosure (e.g., fabricated at least in part by the same additive manufacturing process, or other (additive manufacturing) processes/methods. For example, an electron-beam additive manufactured monolith support structure or substrate can be assembled with one or more laser-sintered monolith support structures or substrates.

Moreover, for ease of manufacturing, larger plates/substrates can be fabricated by joining two or more smaller plates/substrates by welding or other joining methods.

The present disclosure provides for a porous assembly including a porous monolith substrate that extends from a first end to a second end; and a sensitive or active layer positioned on the porous monolith substrate; and wherein the porous monolith substrate is fabricated at least in part by additive manufacturing.

The present disclosure also provides for a porous assembly wherein the sensitive or active layer is a porous or solid catalytic, electro-chemically active or electrically conductive or filter or flow membrane.

The present disclosure also provides for a porous assembly wherein the porous monolith substrate takes the form of a screen or 3D printed lattice substrate.

The present disclosure also provides for a porous assembly wherein the porous monolith substrate includes homogenous or graded porosity.

The present disclosure also provides for a porous assembly wherein the porous monolith substrate has a range of pore sizes from 0.1 microns to greater than 1 mm, and a range of porosities from 5 to 95%.

The present disclosure also provides for a porous assembly wherein the porous monolith substrate has a range of dimensions from 0.1 inch to the maximum size of additive manufacturing machines, and wherein the porous monolith substrate is of any shape.

The present disclosure also provides for a porous assembly wherein the porous monolith substrate is fabricated from titanium 6-4 (Grade 5) or CP Titanium (Grade 1).

The present disclosure also provides for a porous assembly wherein the porous monolith substrate comprises a plurality of rings.

The present disclosure also provides for a porous assembly wherein the porous monolith substrate comprises a plurality of polygonal structures.

The present disclosure also provides for a porous assembly wherein the porous monolith substrate comprises a first level, a second level, a third level, a fourth level and a fifth level, each level including a plurality of holes or passages therethrough.

The present disclosure also provides for a method for fabricating a porous assembly including providing a porous monolith substrate that extends from a first end to a second end; and positioning a sensitive or active layer on the porous monolith substrate; and wherein the porous monolith substrate is fabricated at least in part by additive manufacturing.

The present disclosure also provides for a method for fabricating a porous assembly wherein the porous monolith substrate is fabricated at least in part by a 3D printing process.

The present disclosure also provides for a method for fabricating a porous assembly wherein the porous monolith substrate is fabricated at least in part by an electron-beam additive manufacturing process or a laser additive manufacturing process.

The above described and other features are exemplified by the following figures and detailed description.

Any combination or permutation of embodiments is envisioned. Additional advantageous features, functions and applications of the disclosed assemblies, systems and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

The following figures are exemplary embodiments wherein the like elements are numbered alike.

Features and aspects of embodiments are described below with reference to the accompanying drawings, in which elements are not necessarily depicted to scale.

Exemplary embodiments of the present disclosure are further described with reference to the appended figures. It is to be noted that the various features, steps, and combinations of features/steps described below and illustrated in the figures can be arranged and organized differently to result in embodiments which are still within the scope of the present disclosure. To assist those of ordinary skill in the art in making and using the disclosed assemblies, systems and methods, reference is made to the appended figures, wherein:

FIG. 1 is a schematic of assemblies of multiple separate/individual porous layers (e.g., conventional screens/sintered metal porous metal media), each assembly of multiple porous layers configured to build a support structure for a sensitive or active layer of a multi-layer application (e.g., for sensitive/active layers in fuel cell/electrolyzer/battery/other multi-layer applications).

FIG. 2 is a schematic of exemplary porous assemblies, each porous assembly including a porous monolith support structure or substrate for a sensitive or active layer of a multi-layer application (e.g., for sensitive/active layers in fuel cell/electrolyzer/battery/other multi-layer applications), according to the present disclosure.

FIG. 3 depicts a first side view (e.g., bottom side view) of a porous monolith support structure or substrate according to the present disclosure.

FIG. 4 depicts a first side perspective view (e.g., bottom side perspective view) of a porous monolith support structure or substrate according to the present disclosure.

FIG. 5 depicts a second side view (e.g., top side view) of a porous monolith support structure or substrate according to the present disclosure.

FIG. 6 depicts a second side perspective view (e.g., top side perspective view) of a porous monolith support structure or substrate according to the present disclosure.

FIG. 7 depicts another second side perspective view (e.g., top side perspective view) of a porous monolith support structure or substrate according to the present disclosure.

FIG. 8 is a partial exploded view of FIG. 7.

FIG. 9 depicts a top side perspective view of another porous monolith support structure or substrate according to the present disclosure.

FIGS. 10 and 11 are side edge views of the structure or substrate of FIG. 9.

FIG. 12 is a top side perspective view of a first level of the structure or substrate of FIG. 9.

FIG. 13 depicts exemplary rings of first level of the structure or substrate of FIG. 9.

FIG. 14 depicts a top side perspective view of another porous monolith support structure or substrate according to the present disclosure.

FIG. 15 depicts a bottom side perspective view of the porous monolith support structure or substrate of FIG. 14.

FIG. 16 is a side perspective view of a covered hexagonal structure of the porous monolith support structure or substrate of FIG. 14.

FIG. 17 is a side perspective view of an uncovered hexagonal structure of the porous monolith support structure or substrate of FIG. 14.

FIG. 18 is a side perspective view of a covering for a hexagonal structure of the porous monolith support structure or substrate of FIG. 14.

### DETAILED DESCRIPTION OF THE DISCLOSURE

The exemplary embodiments disclosed herein are illustrative of advantageous porous assemblies, and systems of the present disclosure and methods/techniques thereof. It should be understood, however, that the disclosed embodiments are merely exemplary of the present disclosure, which may be embodied in various forms. Therefore, details disclosed herein with reference to exemplary porous assemblies and associated processes/techniques of fabrication/assembly and use are not to be interpreted as limiting, but merely as the basis for teaching one skilled in the art how to make and use the advantageous porous assemblies and/or alternative porous assemblies of the present disclosure.

The present disclosure provides advantageous porous assemblies, and improved systems/methods for utilizing and/or fabricating the porous assemblies.

More particularly, the present disclosure provides porous assemblies fabricated at least in part by additive manufacturing (e.g., via a 3D printing process, such as, for example, via an electron-beam additive manufacturing process, via a laser additive manufacturing technology, via an inkjet or a binder-jet additive manufacturing process, etc.), the porous assemblies including a porous monolith support structure or substrate for a sensitive or active layer of a multi-layer application (e.g., for sensitive/active layers in fuel cell/electrolyzer/battery/other multi-layer applications).

Referring now to the drawings, like parts are marked throughout the specification and drawings with the same reference numerals, respectively. Drawing figures are not necessarily to scale and in certain views, parts may have been exaggerated for purposes of clarity.

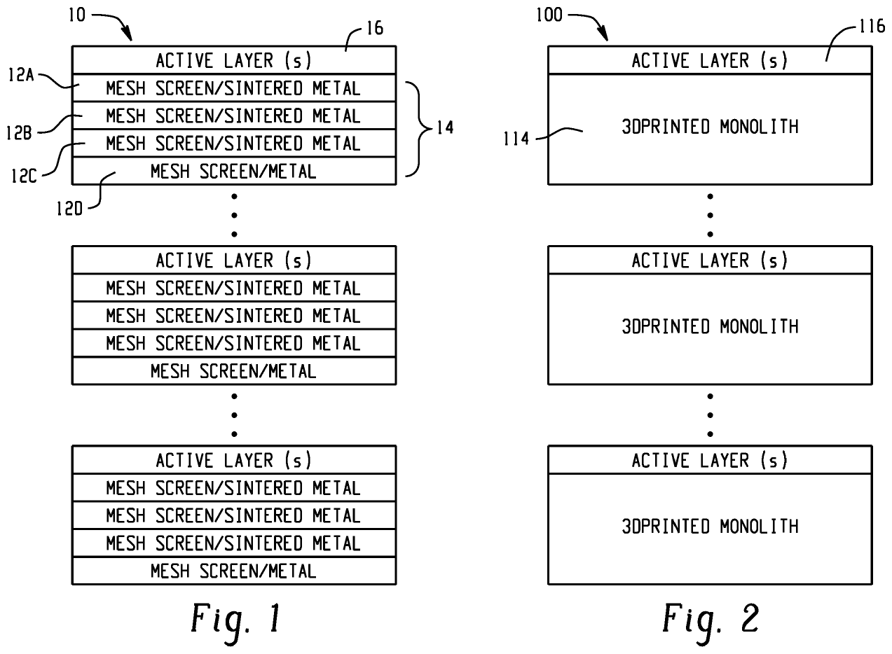

As shown in FIG. 1, current practice provides for a multi-layer assembly 10 of multiple separate/individual porous layers 12A to 12D (e.g., conventional screens/sintered metal porous metal media 12A to 12D) to build a multi-layer support structure 14 for sensitive/active layers 16 of multi-layer applications (e.g., for sensitive/active layers 16 in fuel cell/electrolyzer/battery/other multi-layer applications) to be positioned thereon. Such assemblies 10 are repeated throughout the stack structure. For example, a typical fuel cell stack may have tens of such assemblies 10, if not more. This often results in multiple/costly fabrication and additional processing (such as application of coating on each separate/individual layer 12A, 12B, etc. before fabrication) steps. Also, the performance (e.g., fluid flow resistance) that is achieved can be limited by the lack of flexibility in designing the pore structure and/or dimensions of the multiple separate porous layers 12A to 12D (e.g., conventional screens/sintered metal porous metal media 12A to 12D).

In exemplary embodiments and as shown in FIG. 2, the present disclosure provides porous assemblies 100 fabricated at least in part by additive manufacturing (e.g., via a 3D printing process), each porous assembly 100 including a porous monolith support structure or substrate 114 for a sensitive or active layer 116 of a multi-layer application (e.g., for sensitive/active layers 116 in fuel cell/electrolyzer/battery/other multi-layer applications) to be positioned thereon, thereby providing significant operational, manufacturing, commercial and/or revenue advantages as a result, and as discussed further below.

FIG. 2 is a schematic of exemplary porous assemblies 100, each porous assembly 100 including a porous monolith support structure or substrate 114 for one or more sensitive or active layers 116 of a multi-layer application to be positioned and/or attached thereon.

For example, the sensitive or active layer 116 can be a filter membrane 116 (e.g., a porous metal fiber filter membrane 116) or the like. It is noted that the sensitive or active layer 116 can be a porous or solid catalytic, electro-chemically active or electrically conductive or filter or flow membrane 116.

It is noted that the porous monolith support structure or substrate 114 is fabricated at least in part by additive manufacturing, and can take the form of a screen or 3D printed lattice substrate 114.

In exemplary embodiments, the present disclosure provides for a 3D printed monolith 114 with homogenous or graded porosity that can replace the conventional fabrication of assembly 10 of multiple separate porous layers 12A-12D (sintered metal or screens), and thus eliminate multiple fabrication steps (cost effective), and can improve performance through optimization of the pore microstructure and tortuosity for fluid flow of monolith 114.

In example embodiments, a fully 3D printed porous monolith layer/substrate 114 can replace two or more conventional separate screens 12 (e.g., 12A to 12D) that are each 0.005-0.02 inches thick. The 3DP monolith 114 can have a wide range of pore sizes (e.g., from 0.1 microns to greater than 1 mm (e.g. lattice structures)), and a wide range of porosities (e.g., from 5 to 95%). It is noted that the porous monolith substrate 114 can have a range of dimensions (e.g., from 0.1 inch to the maximum size allowed by additive manufacturing machines (e.g., 14×14 inch); and that the porous monolith substrate 114 can be of any shape (e.g., square, rectangle, circle, etc.).

It is noted that the porous monolith substrate 114 can primarily be used in gas/energy generation applications, and may also be used for any application requiring improved fluid flow and simple designs/fabrication for reduced cost.

As noted, the porous monolith support structure or substrate 114 is fabricated at least in part by additive manufacturing (e.g., via a 3D printing process, such as, for example, via an electron-beam additive manufacturing process, via a laser additive manufacturing technology, via an inkjet or a binder-jet additive manufacturing process, etc.). It is noted that other additive manufacturing processes can be utilized for substrate 114 (e.g., a fused deposition modeling (“FDM”) process; utilizing laser additive manufacturing technology (“LAMT”), etc.).

The additive manufacturing or 3D printing processes as described herein can be used to manufacture substrates 114 with basic or complex shapes/designs (e.g., and that are highly effective yet small in shape).

It is noted that the shapes/designs of the substrates 114 of the present disclosure that may be manufactured using additive manufacturing or a 3D printing processes can yield complex fluid flow patterns.

It is noted that a myriad of geometries for substrate 114 are possible (e.g., circles, squares, odd shapes, etc.).

Multiple conventional separate porous layers (e.g., 12A to 12D) can be replaced by one 3D printed layer/substrate 114. As such, multiple fabrication steps are advantageously eliminated.

With 3D printed layer/substrate 114, the design freedom expands. For example, the 3D printed pore structure tortuosity of substrate 114 can be designed to optimize performance (fluid flow).

Moreover, graded porosities of substrate 114 are possible.

It is noted that two or more 3D printed monoliths 114 can be combined, if desired.

It is also noted that adjacent components (e.g., adjacent solid components) can be 3D printed along with the porous monolith 114.

The present disclosure provides that porous monolith 114 can be fabricated utilizing a host of materials (e.g., metals, polymers, etc.).

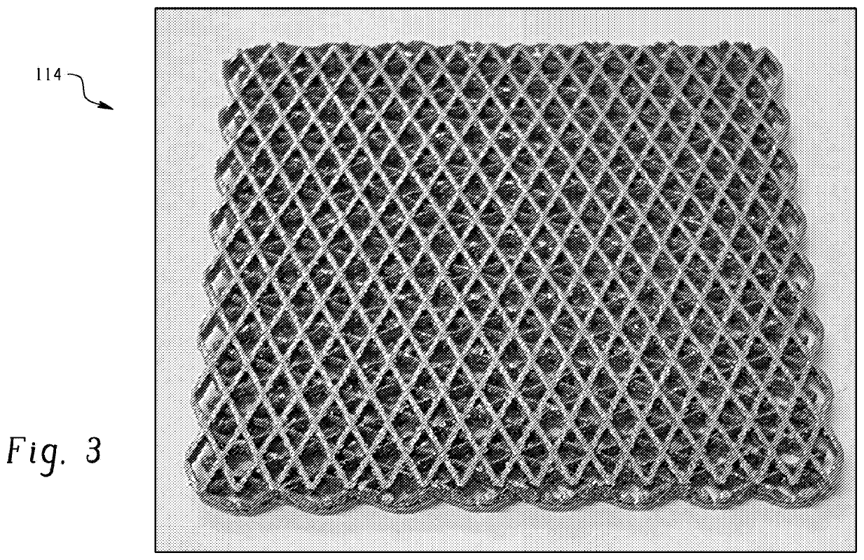

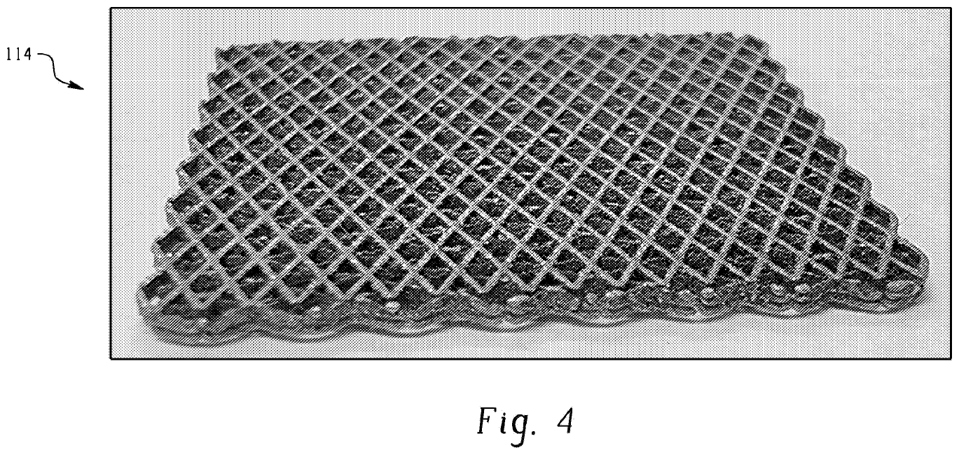

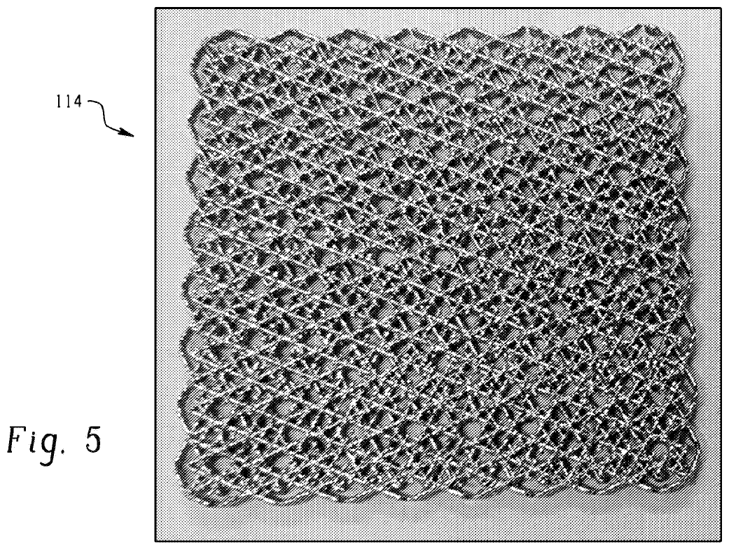

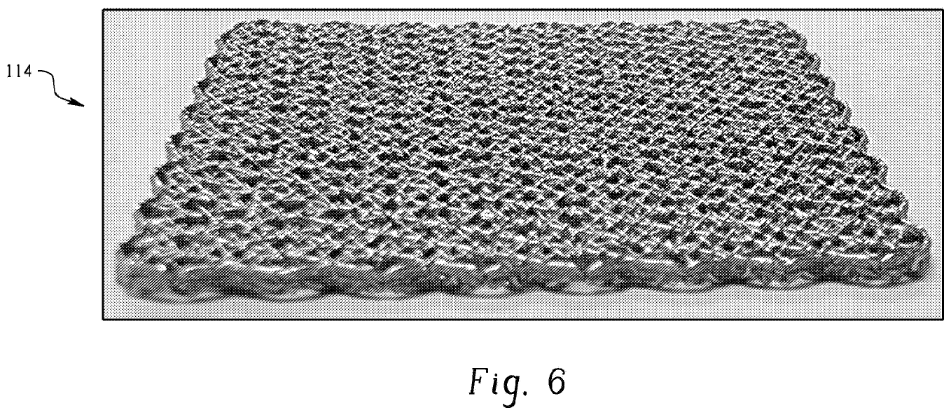

FIG. 3 depicts a first side view (e.g., bottom side view) of an exemplary porous monolith support structure or substrate 114. FIG. 4 depicts a first side perspective view (e.g., bottom side perspective view) of an exemplary porous monolith support structure or substrate 114. FIG. 5 depicts a second side view (e.g., top side view) of an exemplary porous monolith support structure or substrate 114. FIG. 6 depicts a bottom side perspective view of an exemplary porous monolith support structure or substrate 114.

In some embodiments, exemplary porous monolith support structure or substrate 114 can be fabricated from titanium 6-4 (Grade 5) or CP Titanium (Grade 1), although the present disclosure is not limited thereto. Rather, it is noted that porous monolith support structure or substrate 114 can be fabricated from a variety of materials.

As noted, the porous monolith support structure or substrate 114 is fabricated at least in part by additive manufacturing (e.g., via a 3D printing process, such as, for example, via an electron-beam additive manufacturing process, via a laser additive manufacturing technology, via an inkjet or a binder-jet additive manufacturing process, etc.)

In some embodiments, the porous monolith support structure or substrate 114 can have a length of 1 inch, a width of 1 inch, and an overall height or thickness of around 0.045 inches. In other embodiments, the porous monolith support structure or substrate 114 can have a length of 3 inches, a width of 3 inches, and an overall height or thickness of around 0.045 inches. However, it is noted that the porous monolith support structure or substrate 114 can have a variety of sizes, shapes and forms.

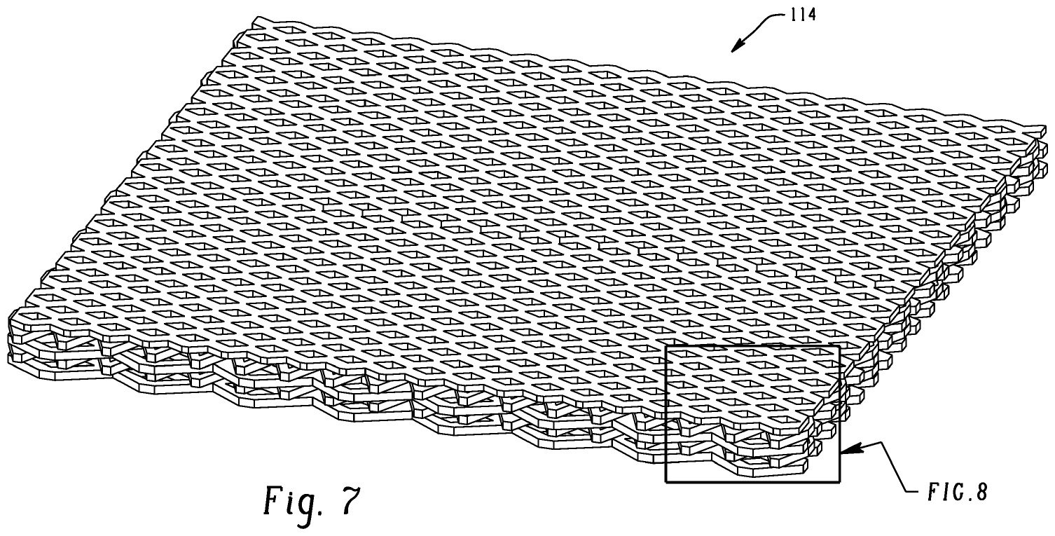

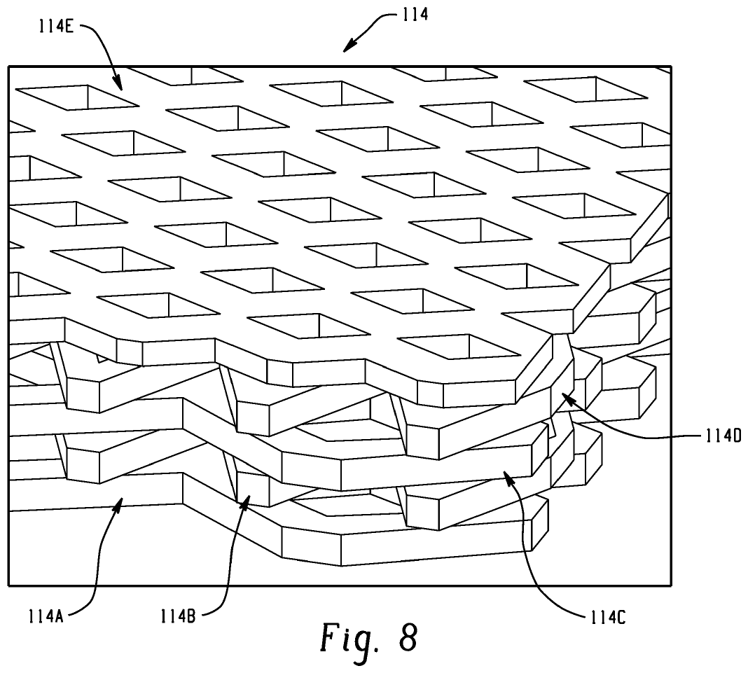

FIG. 7 depicts another second side perspective view (e.g., top side perspective view) of an exemplary porous monolith support structure or substrate 114. FIG. 8 is a partial exploded view of FIG. 7.

As shown in FIG. 8, porous monolith support structure or substrate 114 can be fabricated to have a first level 114A, a second level 114B, a third level 114C, a fourth level 114D and a fifth level 114E. In exemplary embodiments, each level 114A to 114E includes a plurality of holes or passages therethrough.

In some embodiments, first level 114A, second level 114B, third level 114C and fourth level 114D are all coarser than fifth level 114E (e.g., top side level 114E), with fifth level 114E being finer than levels 114A to 114D.

In certain embodiments, first level 114A, second level 114B, third level 114C and fourth level 114D are each about 0.010 inches in height, and the fifth level 114E is about inches in height.

In exemplary embodiments, the orientation of second level 114B is rotated 90 degrees relative to first level 114A, and the orientation of third level 114C is rotated 90 degrees relative to second level 114B, and the orientation of fourth level 114D is rotated 90 degrees relative to third level 114C. This thereby creates a tortuous fluid flow path from level to level when the levels 114A to 114D are fabricated on top of each other to create porous monolith support structure or substrate 114.

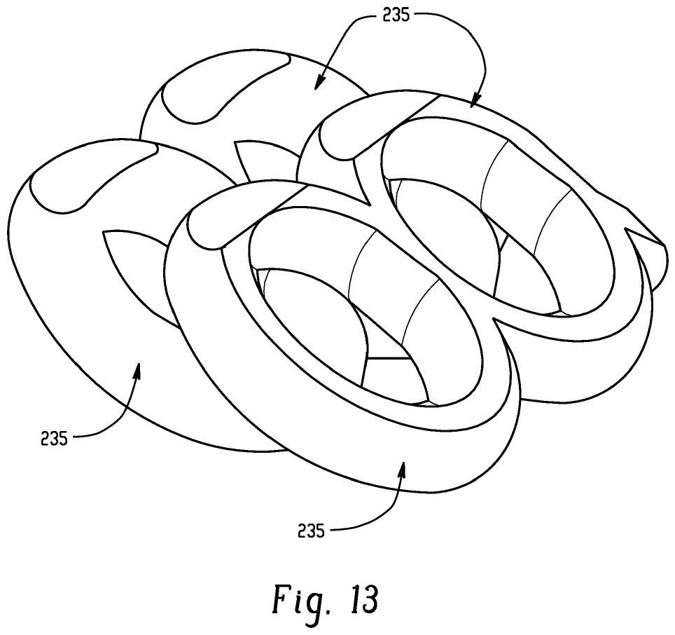

In another embodiment and as shown in FIGS. 9-13, porous monolith support structure or substrate 214 can be fabricated to have a first level 214A and a second level 214B, with the first level 214A comprising a plurality of rings 235.

In exemplary embodiments, individual rings 235 of the plurality of rings 235 are each laid on their sides with flats on their tops and bottoms. In example embodiments and without limitation, each ring 235 can have a 0.052″ ring diameter, 0.015″ wall thickness, height (flat to flat), and a 30° tilt angle from the horizon.

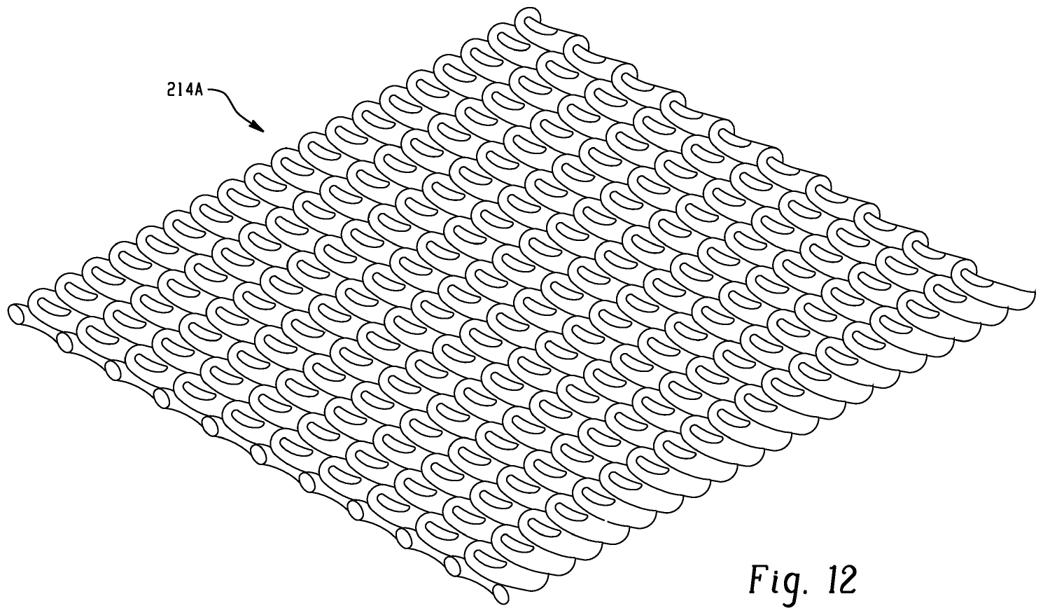

First level 214A can be a 1″×1″×0.035″ plate fabricated by stacking rings 235 in the x and y directions as shown in FIG. 12.

Second level 214B (e.g., top level 214B) can be fabricated as a top plate with numerous through holes 241 therethrough. For example, second level 214B can have dimensions of 1″×1″×0.010″, with hole 241 diameters of 0.010″ and hole 241 spacing of 0.010″.

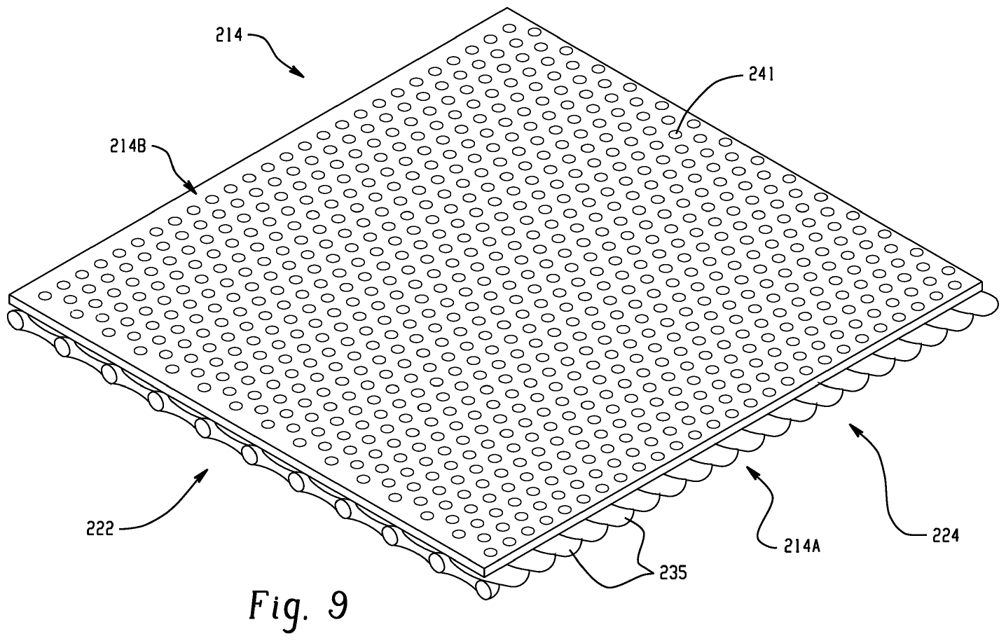

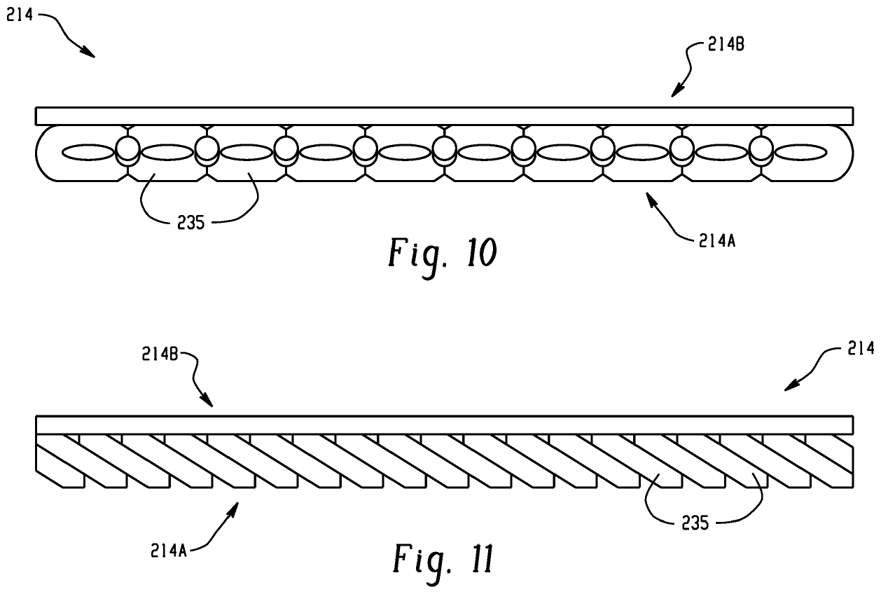

In exemplary embodiments, FIG. 10 shows a first edge 222 view showing a more open structure, and FIG. 11 shows second edge 224 view showing a less open structure.

In example embodiments and without limitation, structure or substrate 214 can be fabricated with top plate 214B located on top of ring structure 214A to make a monolith 214 with dimensions of 1″×1″×0.045″ thickness or height.

It is noted that the in-plane flow in one direction (222) will be significantly different than the flow in the other direction (224) of porous monolith support structure or substrate 214.

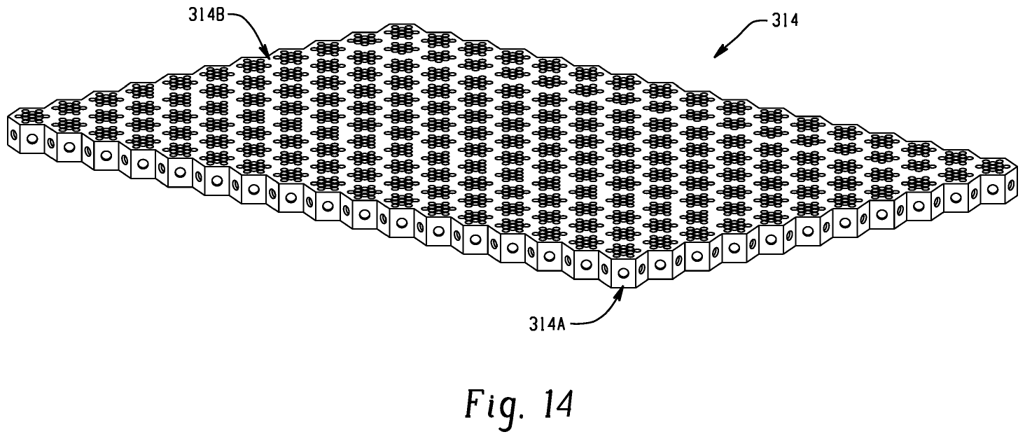

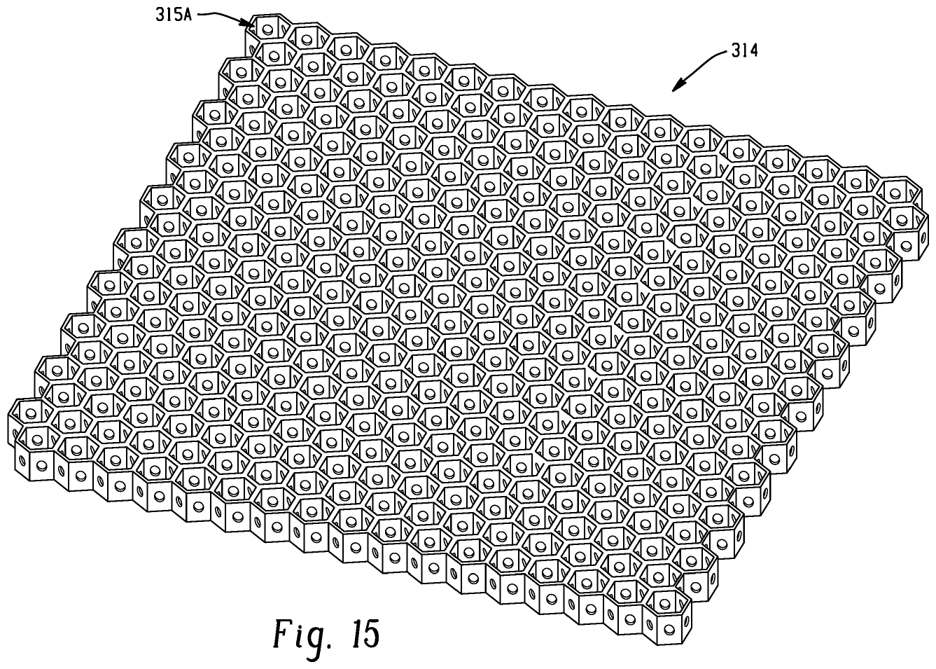

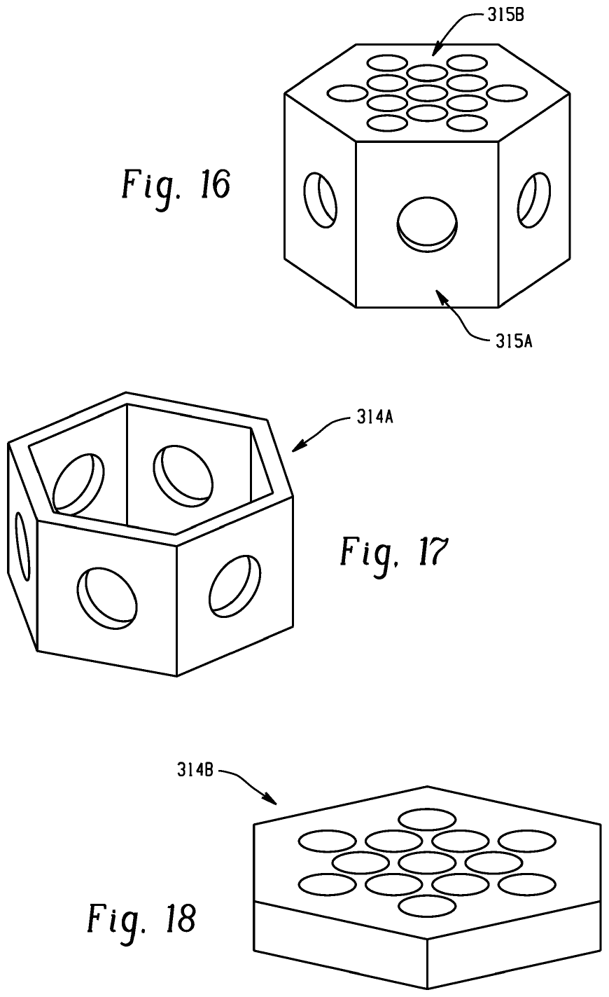

In another embodiment and as shown in FIGS. 14-18, porous monolith support structure or substrate 314 can be fabricated to have a first level 314A and a second level 314B, with the first level 314A comprising a plurality of hexagonal structures 314A (e.g., or any other polygonal structure 314A), and with the second level 314B comprising a plurality of coverings 314B.

For example and without limitation, three hundred and forty (340) individual hexagonal structures 314A can be fabricated and combined to make a 1″×1″×0.045″ thick sheet monolith 314. The hexagonal structures 314A can be stacked in a close packed pattern to make monolith 314.

In example embodiments, each hexagonal structure 314A includes through holes on the sides for fluid flow/cooling. For example, each hexagonal structure 314A can be 0.035″ high, 0.075″ wide, have a 0.010″ wall, and have 0.015″ diameter holes.

In exemplary embodiments, each thin top layer 314B (e.g., each 0.010″ thick) includes numerous through holes (e.g., each 0.010″ in diameter).

It is noted that one can fabricate the thin layer 314B on the top and bottom of the structure 314A for more surface area contact.

In example embodiments, the combined hexagonal structure 314A with top layer 314B has a combined height of 0.045 inches.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

The ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

1. A porous assembly comprising:
a porous monolith substrate that extends from a first end to a second end; and
a sensitive or active layer positioned on the porous monolith substrate; and
wherein the porous monolith substrate is fabricated at least in part by additive manufacturing.

2. The assembly of claim 1, wherein the sensitive or active layer is a porous or solid catalytic, electro-chemically active or electrically conductive or filter or flow membrane.

3. The assembly of claim 1, wherein the porous monolith substrate takes the form of a screen or 3D printed lattice substrate.

4. The assembly of claim 1, wherein the porous monolith substrate includes homogenous or graded porosity.

5. The assembly of claim 1, wherein the porous monolith substrate has a range of pore sizes from 0.1 microns to greater than 1 mm, and a range of porosities from 5 to 95%.

6. The assembly of claim 1, wherein the porous monolith substrate has a range of dimensions from 0.1 inch to the maximum size of additive manufacturing machines, and wherein the porous monolith substrate is of any shape.

7. The assembly of claim 1, wherein the porous monolith substrate is fabricated from titanium 6-4 (Grade 5) or CP Titanium (Grade 1).

8. The assembly of claim 1, wherein the porous monolith substrate comprises a plurality of rings.

9. The assembly of claim 1, wherein the porous monolith substrate comprises a plurality of polygonal structures.

10. The assembly of claim 1, wherein the porous monolith substrate comprises a first level, a second level, a third level, a fourth level and a fifth level, each level including a plurality of holes or passages therethrough.

11. A method for fabricating a porous assembly comprising:
providing a porous monolith substrate that extends from a first end to a second end; and
positioning a sensitive or active layer on the porous monolith substrate; and
wherein the porous monolith substrate is fabricated at least in part by additive manufacturing.

12. The method of claim 11, wherein the porous monolith substrate is fabricated at least in part by a 3D printing process.

13. The method of claim 11, wherein the porous monolith substrate is fabricated at least in part by an electron-beam additive manufacturing process or a laser additive manufacturing process.

14. The method of claim 11, wherein the sensitive or active layer is a porous or solid catalytic, electro-chemically active or electrically conductive or filter or flow membrane.

15. The method of claim 11, wherein the porous monolith substrate takes the form of a screen or 3D printed lattice substrate.

16. The method of claim 11, wherein the porous monolith substrate includes homogenous or graded porosity.

17. The method of claim 11, wherein the porous monolith substrate has a range of pore sizes from 0.1 microns to greater than 1 mm, and a range of porosities from 5 to 95%.

18. The method of claim 11, wherein the porous monolith substrate is fabricated from titanium 6-4 (Grade 5) or CP Titanium (Grade 1).

19. The method of claim 11, wherein the porous monolith substrate comprises a plurality of rings.

20. The method of claim 11, wherein the porous monolith substrate comprises a plurality of polygonal structures.
